(19) United States
(12) Patent Application Publication
(10) Pub. No.: US 2014/0289309 A1
(43) Pub. Date: Sep. 25, 2014

(54) Media Transformation to Routable Message, or Retrievable Content Based on Key

(71) Applicant: TeleCommunication Systems, Inc., Annapolis, MD (US)

(72) Inventors: Donald LeRoy Mitchell, JR., Bellevue, WA (US); Roger S. Marshall, Auburn, WA (US)

(73) Assignee: TeleCommunication Systems, Inc., Annapolis, MD (US)

(21) Appl. No.: 14/104,764

(22) Filed: Dec. 12, 2013

Related U.S. Application Data
(60) Provisional application No. 61/844,657, filed on Jul. 10, 2013.
(60) Provisional application No. 61/828,878, filed on May 30, 2013.
(60) Provisional application No. 61/803,662, filed on Mar. 20, 2013.

(51) Int. Cl. H04L 29/06

(52) U.S. Cl. CPC H04L 65/605
USPC 709/203

(57) ABSTRACT

A content server enables a content creating device to send media content to a target consumer/destination device with an uncommon media format by transforming media content transmitted or uploaded by a content creator into media content that is either routable or accessible to a target consumer/destination device. In particular, a content creating device embeds captured media content and an address of a target consumer/destination device into a content transformation message and then routes the content transformation message to the inventive content server. The content server then receives the content transformation message and transforms embedded media content into either a routable SIP signaling message with actual media content or a routable SIP signaling message with retrievable media content. Once media transformation is complete, the content server sends the routable message with actual/retrievable media content to the target consumer/destination device indicated in the content transformation message.

The present application claims priority from U.S. Provisional No. 61/803,662, filed Mar. 20, 2013, entitled “A Method for Establishing and Using an Index of Suspicion”; and from U.S. Provisional No. 61/828,878, filed May 30, 2013, entitled “Media Transformation to Routable Message, Or Retrievable Content Based On Key”; and from U.S. Provisional No. 61/844,657, filed Jul. 10, 2013, entitled “Media Transformation to Routable Message, Or Retrievable Content Based On Key”, the entirety of all of which are expressly incorporated herein by reference.

### BACKGROUND OF THE INVENTION

1. Field of the Invention

This invention relates generally to wireless telecommunications, and in particular to public safety, location services, SMS, MMS/MMES and other text messaging.

2. Background of Related Art

The Federal Communications Commission (FCC) has recently announced plans to support short messaging service (SMS) to 911 and is expected to extend their announcement in the future to also support MMS/MMES capabilities that include text, image(s), audio, captured video, and streaming video content. However, due to a large and growing number of technological devices and platforms, it has become increasingly difficult to ensure successful and efficient transmission of media content between dissimilar devices, platforms, and/or networks. For instance, due to contrasting content requirements, media transmission between two distinct devices/platforms/networks may be less than satisfactory, which may in turn affect user experience.

To support multimedia messaging service (MMS) or multimedia emergency services (MMES) to 911 and streaming text, audio, and video to 911 capabilities, ramifications due to inefficient media transmission must be resolved. Hence, a sufficient media content transformation and routing service is needed.

### SUMMARY

A method and apparatus for transforming media content (e.g. a still frame picture/image, video file, streaming video, audio file, text, etc.) transmitted or uploaded by a content creator (i.e. a device that captures/transmits media content) into media content that is routable or accessible to a target consumer/destination device, e.g., a public safety answering point (PSAP), a computing platform, a command center, etc., comprises a content server. In accordance with the principles of the present invention, the inventive content server (i.e. an intermediary network component) enables a content creating device to seamlessly transmit media content (e.g. a joint photographic experts group (JPEG) file, a moving picture experts group (MPEG4) file, an advanced audio coding (AAC) file, a QuickTime file, etc.) to a target consumer/destination device (e.g., a PSAP, a computing platform, a command center, etc.) with a dissimilar media format.

In accordance with the principles of the present invention, to route media content to a target consumer/destination device with a dissimilar media format, an originating (content creating) device embeds captured media content and an address of a target consumer/destination device into a content transformation message, and then routes the content transformation message to the inventive content server. Media content embedded in a content transformation message may or may not contain embedded or associated location (i.e. geographic position) and/or time (i.e. a validated time stamp) information.

In accordance with the principles of the present invention, the inventive content server comprises a media collection point service module and a media content transformation module. The media collection point service module on the inventive content server retrieves file properties, sender identification information, and location and/or time information associated with media content embedded in a content transformation message. Moreover, the media content transformation module on the inventive content server transforms media content embedded in a content transformation message into a routable message with actual media content, or a routable message with retrievable media content, and then routes the routable message with actual/retrievable media content to a target consumer/destination device.

In accordance with the principles of the present invention, a session initiation protocol (SIP) signaling message is preferably used to route actual/retrievable media content to a target consumer/destination device.

### BRIEF DESCRIPTION OF THE DRAWINGS

Features and advantages of the present invention will become apparent to those skilled in the art from the following description with reference to the drawings, in which:

FIG. 1 depicts an exemplary content server, in accordance with the principles of the present invention.

FIG. 2 shows exemplary media transformation and routing, in accordance with the principles of the present invention.

### DETAILED DESCRIPTION OF ILLUSTRATIVE EMBODIMENTS

The present invention comprises a content server (i.e. a transitional network component) that transforms media content (e.g. a photo, a video, streaming video, an audio file, streaming audio, a text message, etc.) transmitted or uploaded by a content creator (i.e. a device that captures/transmits media content) into media content that is either routable or accessible to a target consumer/destination device, e.g., a public safety answering point (PSAP), a computing platform, a command center, etc. In accordance with the principles of the present invention, the inventive content server enables a content creating device to seamlessly transmit media content (e.g. a joint photographic experts group (JPEG) file, a moving picture experts group (MPEG4) file, an advanced audio coding (AAC) file, a QuickTime file, etc.) to a target consumer/destination device (e.g., a PSAP, a computing platform, a command center, etc.) with a dissimilar media format.

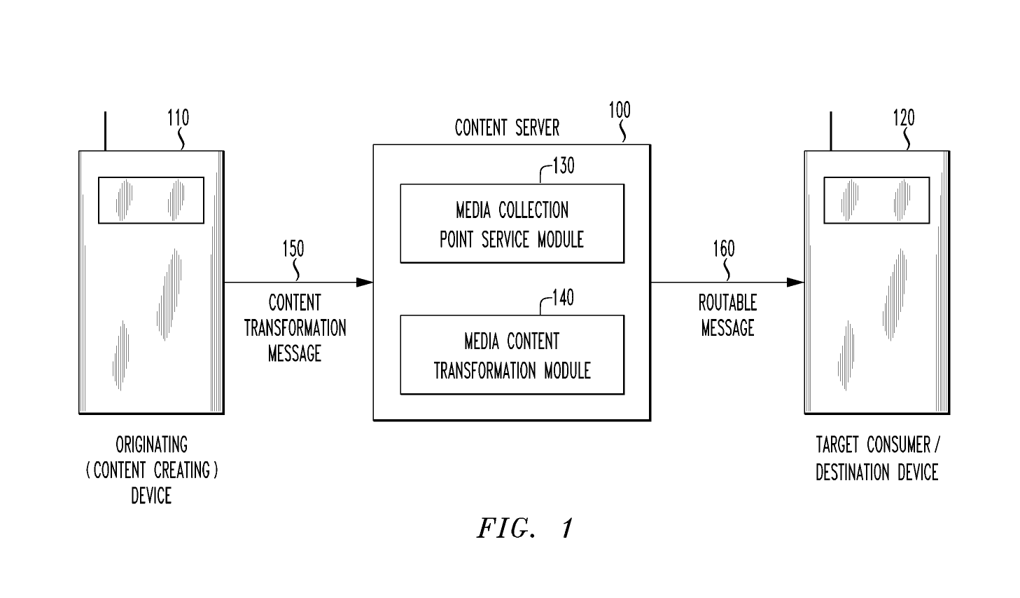

FIG. 1 depicts an exemplary content server, in accordance with the principles of the present invention.

In accordance with the principles of the present invention, to route media content to a target consumer/destination device 120 with a dissimilar media format, an originating (content creating) device 110 embeds captured media content and an address of a target consumer/destination device into a content transformation message 150, and then routes the content transformation message 150 to the inventive content server 100. Media content embedded in a content transformation message 150 may or may not contain embedded or associated location (i.e. geographic position) and/or time (i.e. a validated time stamp) information.

As depicted in FIG. 1, the inventive content server 100 comprises a media collection point service module 130 and a media content transformation module 140. The media collection point service module 130 on the inventive content server 100 determines properties, sender identification information, and position and/or time information associated with media content embedded in a content transformation message 150.

Moreover, the media content transformation module 140 on the inventive content server 100 transforms media content embedded in a content transformation message 150 into a routable message 160 with actual media content (i.e. media content received in a content transformation message 150) or a routable message 160 with retrievable media content (i.e. a routable message 160 with a link to actual media content). In particular, the inventive media content transformation module 140 preferably transforms media content embedded in a content transformation message 150 into a conventional session initiation protocol (SIP) message (i.e. a routable message), for purposes of routing the actual/retrievable media content to a target consumer/destination device 120 (even when received media content is not originally based on or related to session initiation protocol (SIP) signaling standards). A database dereference key is optionally inserted into the body of a SIP signaling message 160 to provide a link to actual media content. When a link to actual media content is inserted into the body of a SIP signaling message 160, media content embedded in a relevant content transformation message 150 is transformed into a database entry based on that key and content.

In accordance with the principles of the present invention, actual media content embedded in a routable message (e.g. a SIP signaling message) 160 and transmitted to a target consumer/destination device 120 may be viewed upon receipt. Alternatively, a database dereference key embedded in a routable message (e.g. a SIP signaling message) 160 and transmitted to a target consumer/destination device 120 may be used to retrieve actual media content over a conventional transmission control protocol/internet protocol (TCP/IP) network.

In accordance with the principles of the present invention, the media content transformation module 140 routes a routable message 160 with actual/retrievable media content to a target consumer/destination device 120 based on location information obtained in association with that media content. In particular, if media content delivered to the content server 100 includes location information (either embedded or externally supplied), then the media content transformation module 140 routes a routable message (e.g. a SIP signaling message) with that actual/retrievable media content to a target/consumer destination device 120 based on location information received therewith. Alternatively, when media content is delivered to the content server 100 without location information, the media content transformation module 140 routes a routable message 160 with that actual/retrievable media content to a target consumer/destination device 120 based on location information obtained for an originating (content creating) device 110.

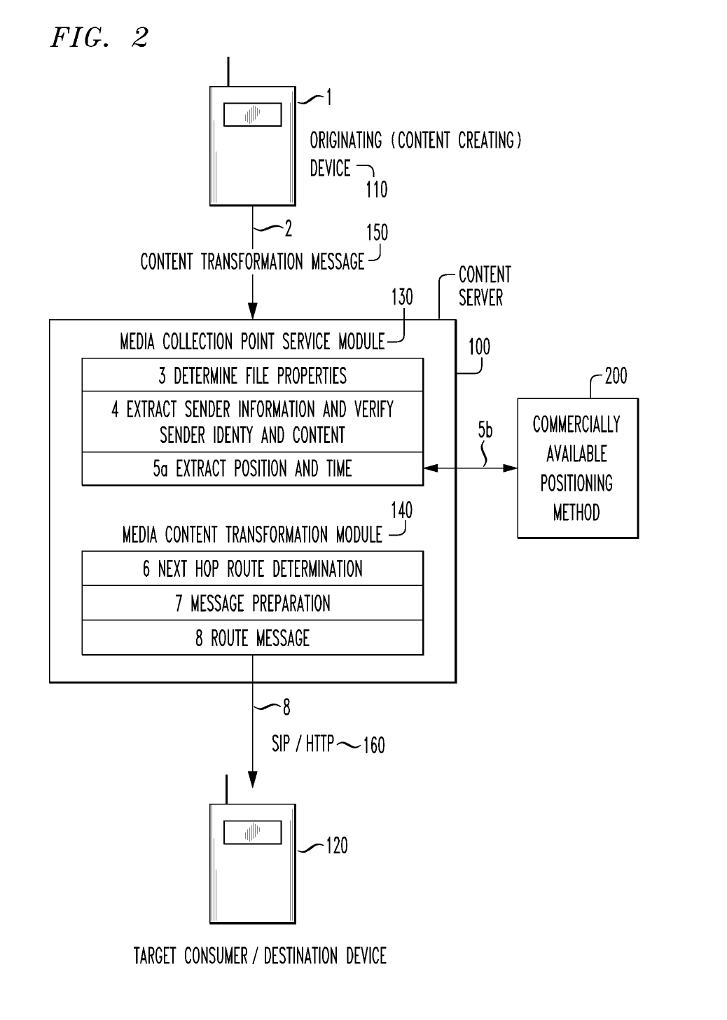

FIG. 2 depicts exemplary media content transformation and routing, in accordance with the principles of the present invention.

In particular, as depicted in step 1 of FIG. 2, an originating (content creating) device 110 captures media content (e.g., a still frame picture, video, audio, text, etc.) and saves the media content in a local file with an appropriate file extension (i.e. a media file extension), e.g., joint photograph expert group (JPEG), QuickTime, moving picture experts group (MPEG4), advanced audio coding (AAC), etc. If possible, the originating (content creating) device 110 determines a current position of the device 110 (using a commercially available positioning method 200) and inserts the position into the metadata fields of the media file. A conventional WGS84 positioning method is preferably used to determine positioning information, though any positioning determination method may be used (as long as an employed positioning determination method is indicated in the metadata fields of the media file).

As depicted in step 2 of FIG. 2, to route the media file (e.g. a JPEG, QuickTime, MPEG4, AAC, etc., file) to a desired consumer/destination device 120, the originating (content creating) device 110 embeds the media file and the address of the target consumer/destination device 120 into a content transformation message 150, and then routes the content transformation message 150 over a transmission control protocol/internet protocol (TCP/IP) network to the inventive content server 100 (via use of a well-known uniform resource locator (URL)). The originating (content creating) device 110 also adds a location description to the media file, if the device application supports such capability. In accordance with the principles of the present invention, the following transmission methods may be used to route a content transformation message 150 to the inventive content server 100: upload (file transfer protocol (ftp)), e-mail, multi-media messaging service (MMS/MMES), session initiation protocol (SIP) attachment, session initiation protocol for instant messaging and presence leveraging extension (SIP/SIMPLE), extensible messaging and presence protocol (XMPP), etc.

Moreover, in an alternative embodiment, the originating (content creating) device 110 uses a portal page to upload the content transformation message 150 to the inventive content server 100. In this scenario, the originating (content creating) device 110 adds a location description to the media file, prior to uploading (if the portal page supports such capability).

In step 3 of FIG. 2, a centralized media collection point service module 130 on the inventive content server 100 receives the content transformation message 150 and determines the properties of the media file embedded therein. The media collection point service module 130 also extracts sender information (e.g. a multimedia message service (MMS/MMES) address, an email address, a telephone number, etc.) from the media file, and uses the extracted sender information to verify a sender identity (step 4). The media collection point service module 130 uses a sender identity to confirm that the originating (content creating) device 110 is a mobile device, capable of being located via commonly available location techniques for wireless protocols, or a fixed line device that may be easily located and verified.

The media collection point service module 130 preferably uses various known methods to ensure that capture time and location information accompanying media content received in the content transformation message 150 is accurate. For instance, in one particular embodiment, an index of suspicion may be embedded in, or routed with the media content, as a means of providing additional content validation. An index of suspicion may potentially prevent or dissuade disinformation created when false location and/or false time information is embedded in a media file. A relevant index of suspicion feature is disclosed in co-pending US Provisional Appl. No. 61/803,662 entitled “A Method for Establishing and Using an Index of Suspicion” filed Mar. 20, 2013, the entirety of which is explicitly incorporated herein by reference.

In accordance with the principles of the present invention, the media collection point service module 130 on the inventive content server 100 also determines whether or not media content embedded in the content transformation message 150 contains positioning information (step 5a), by analyzing the extension attached to the media file and the transmission method used to route the content transformation message 150 to the content server 100. If it is determined that media content embedded in the content transformation message 150 does include positioning information, then the media collection point service module 130 extracts positioning information therefrom. Alternatively, if it is determined that media content embedded in the content transformation message 150 does not include positioning information, then the media collection point service module 130 requests positioning information for the originating (content creating) device 110 from a commercially available positioning determination method 200 (step 5b). The media collection point service module 130 may also choose to collect any of the following information for the originating (content creating) device 110: acceleration, velocity, heading (i.e. degrees from North), with or without azimuth metrics; angle of attitude (i.e. degrees from the horizontal); and elevation (i.e. above datum), etc.

As shown in step 6 of FIG. 2, an inventive media content transformation module 140 on the content server 100 uses positioning information embedded in or supplied in accompany to media content, or positioning information obtained for the originating (content creating) device 110, to determine a next hop uniform resource identifier (URI) for the media content.

Following next hop route determination, the media content transformation module 140 constructs a SIP signaling message 160 (i.e. a routable message) and inserts media content received in the content transformation message 150, or a link to media content received in the content transformation message 150, into the body of the message 160, as shown in step 7. A dereference key to a database element containing media content received in the content transformation message 150 is inserted into the SIP signaling message 160 to provide a link to the actual media content. If a database dereference key is embedded in the SIP signaling message 160, then the media content transformation module 140 transforms media content received in the content transformation message 150 into a database entry, based on the key and content. The media content transformation module 140 also inserts sender information into the SIP signaling message 160.

In step 8 of FIG. 2, the media content transformation module 140 routes the SIP signaling message 160 holding actual/retrievable media content to the next hop uniform resource identifier (URI) (identified in step 6). If the target consumer/destination device 120 indicated in the content transformation message 150 is a SIP based network, then the media content transformation module 140 routes media content with the SIP signaling message 160 to the next hop uniform resource identifier (URI). Alternatively, if the target consumer/destination device 120 indicated in the content transformation message 150 is an internet protocol (IP) client, then the media content transformation module 140 routes the routable message 160 to the next hop uniform resource identifier (URI) via a hypertext transfer protocol (HTTP).

The present invention may be used to send a multimedia messaging service (MMS/MMES) message and/or streaming video content to emergency dispatch personnel. For instance, an individual that witnesses an emergency situation, e.g. a car accident, can use the disclosed invention to send media content (e.g. pictures, audio, video, text, etc.) of the emergency situation to emergency dispatch services, e.g., a public safety answering point (PSAP). Captured media content (e.g. text, audio, video, still frame picture, etc.) may or may not contain positioning information and/or validated (i.e., actual, not spoofed) time information (e.g. a time stamp).

In an emergency situation, a public emergency services address (e.g., “911M” (“M” for media)) may be embedded in a content transformation message 150 to indicate a target consumer/destination device. In accordance with the principles of the present invention, the media content transformation module 140 uses time and/or location information embedded in or received/retrieved in accompany to media content to determine an appropriate public safety answering point (PSAP) to route media content to.

Moreover, the present invention also enables users to view events on a large geographic scale. For instance, the present invention enables mobile and stationary media collection devices that capture media content (e.g. pictures, audio, video, text, etc.), location information, and real time information, to send captured media content, an address of a target consumer/destination device (e.g. a special purpose computing platform) 120, and media capture time and location information, to the inventive content server 100 in a content transformation message 150. Upon receipt of the content transformation message 150, the media content transformation module 140 on the content server 100 can transmit a discrete set of packaged media content to the indicated target consumer/destination device (e.g. a special purpose computing platform) 120 via SIP signaling. In accordance with the principles of the present invention, the media content transformation module 140 routes packaged media content to a target consumer/destination device 120 based on location information measured/provided during media acquisition and/or based on location information provided in accompany to media content.

Moreover, in a combat scenario, there may be a need to see a complete view of a situation occurring on a battlefield. The present invention enables mobile and stationary media collection devices that capture media content, real-time location, and orientation information, to send relevant media content (e.g., pictures, audio, video, text, etc.), an address of a target consumer/destination device 120, and media capture time and location information to the inventive content server 100 in a content transformation message 150. Upon receipt of the content transformation message 150, the media content transformation module 140 on the content server 100 can transmit the media content and associated time and location information as a continuous stream to the target consumer/destination device (e.g. a computing platform on a centralized command center) 120, to permit subsequent media aggregation and display. Media content may then be pieced together on the consumer/destination device 120 to form a crowd-sourced pictograph via use of a commercially available display format.

The inventive content server 100 makes media content accessible in a common format to operators or machines after transformation to a common media format and after routing based on relevant positioning information.

For media collation purposes, a message, such as, “send your photos and videos to xxxxx”, may be broadcast to consumers. Media, including embedded and validated location and/or time information, may then be collated based on location and/or time.

Moreover, social media platforms, such as facebook™, may be improved in light of the present invention, to include a clickable ‘record event’ button. A ‘record event’ button preferably captures media content and determines and embeds associated location and/or time information into the recorded media content (e.g. a photo, video, audio, text, etc.), so that media content and embedded location and/or time information may be collated within a centralized server system.

The present invention may be used to support multimedia messaging service (MMS/MMES) to 911 including streaming audio, text, and/or video content to 911 services.

Moreover, the invention has particular applicability to the service industry, emergency services, and to any method that transforms media content into a database entry based on a key and content.

While the invention has been described with reference to the exemplary embodiments thereof, those skilled in the art will be able to make various modifications to the described embodiments of the invention without departing from the true spirit and scope of the invention.

What is claimed is:

1. A content server to transform and physically route media content between devices with dissimilar media formats, comprising:
a media collection point service module to receive a content transformation message from a content creating device; and
a media content transformation module to transform and physically route media content embedded in said content transformation message to a target destination device.

2. The content server to transform and physically route media content between devices with dissimilar media formats according to claim 1, wherein:
said media content is a photo.

3. The content server to transform and physically route media content between two devices with dissimilar media formats according to claim 1, wherein:
said media content is a video.

4. The content server to transform and physically route media content between two devices with dissimilar media formats according to claim 1, wherein:
said media content is streaming video.

5. The content server to transform and physically route media content between two devices with dissimilar media formats according to claim 1, wherein:
said media content is text.

6. The content server to transform and physically route media content between devices with dissimilar media formats according to claim 1, wherein:
said media content is an audio file.

7. The content server to transform and physically route media content between two devices with dissimilar media formats according to claim 1, wherein:
said media content is streaming audio.

8. The content server to transform and physically route media content between devices with dissimilar media formats according to claim 1, wherein said content transformation message comprises:
an identity of said target destination device; and
media content.

9. The content server to transform and physically route media content between devices with dissimilar media formats according to claim 2, wherein said content transformation message also comprises:
a geographic position.

10. The content server to transform and physically route media content between devices with dissimilar media formats according to claim 2, wherein said content transformation message also comprises:
a time stamp.

11. The content server to transform and physically route media content between devices with dissimilar media formats according to claim 1, wherein:
said media collection point service module extracts a file property, sender identification, position, and time, from said media content embedded in said content transformation message.

12. The content server to transform and physically route media content between devices with dissimilar media formats according to claim 1, wherein:
said media content transformation module transforms said media content embedded in said content transformation message into a routable message containing said media content.

13. The content server to transform and physically route media content between devices with dissimilar media formats according to claim 12, wherein:
said routable message is a session initiation protocol (SIP) message.

14. The content server to transform and physically route media content between devices with dissimilar media formats according to claim 1, wherein:
said media content transformation module transforms said media content embedded in said content transformation message into a routable message indicating retrievable media content.

15. The content server to transform and physically route media content between devices with dissimilar media formats according to claim 14, wherein:
said routable message indicating retrievable media content contains a database dereference key pointing to a database element containing media content.

16. The content server to transform and physically route media content between devices with dissimilar media formats according to claim 15, wherein:
said routable message is a session initiation protocol (SIP) message.
